(19) United States
(12) Patent Application Publication
(10) Pub. No.: US 2014/0153789 A1
(43) Pub. Date: Jun. 5, 2014

(54) BUILDING BOUNDARY DETECTION FOR INDOOR MAPS

(71) Applicant: QUALCOMM INCORPORATED, San Diego, CA (US)

(72) Inventors: Abhinav SHARMA, Santa Clara, CA (US); Chandrakant Mehta, Santa Clara, CA (US); Aravindkumar Ilangovan, San Jose, CA (US); Saumitra Mohan Das, Santa Clara, CA (US)

(73) Assignee: QUALCOMM Incorporated, San Diego, CA (US)

(21) Appl. No.: 13/773,409

(22) Filed: Feb. 21, 2013

Related U.S. Application Data
(60) Provisional application No. 61/732,170, filed on Nov. 30, 2012.

(51) Int. Cl. G06K 9/00

(52) U.S. Cl. CPC G06K 9/00637
USPC 382/113

(57) ABSTRACT

A computer-implemented method for detecting a boundary of a building from an indoor map includes providing an electronic raster image of the indoor map. A floor plan included in the map is a first color and a background of the image is a second color. The method includes scanning the image a first time in a plurality of directions and coloring pixels of the image a third color as they are scanned the first time until a pixel is detected that is not the second color. Then the image is scanned a second time in at least two directions. The second scan includes marking a pixel a fourth color for each third color to non-third color and each non-third color to third color transition. The resultant pixels of the fourth color represent the boundary of the building.

### CROSS-REFERENCE TO RELATED APPLICATION

This application claims the benefit of U.S. Provisional Application No. 61/732,170, filed Nov. 30, 2012. U.S. Provisional Application No. 61/732,170 is hereby incorporated by reference.

### TECHNICAL FIELD

This disclosure relates generally to electronic maps, and in particular but not exclusively, relates to electronic maps for use in indoor navigation.

### BACKGROUND INFORMATION

Navigation systems are becoming more and more pervasive in today's market. A navigation system may be utilized to determine a route from a first location to a destination. In some navigation systems, a user may enter a start location and a destination into a mapping application, such as one of the different mapping applications commonly used on a variety of websites.

One popular navigation system utilizes satellite positioning systems (SPS) such as, the global positioning system (GPS). SPS enabled devices may receive wireless SPS signals that are transmitted by orbiting satellites. The received SPS signals are then processed to determine the position of the SPS enabled device.

In addition, some navigation systems may be utilized within an indoor environment, such as a shopping mall, to guide a user to a destination such as a department store or a food court. However, SPS signal reception may be inadequate for indoor locations, so as to make positioning difficult, if not impossible using SPS. Thus, different techniques may be employed to enable positioning with navigation systems for indoor environments. For example, a device may obtain its position by measuring ranges to three or more wireless access points (e.g., through WiFi), which are positioned at known locations.

Therefore, information relating to a layout of the indoor environment, such as the boundary of the building is important in deciding which method to use in determining the position of a navigation assisting device. For example, a device may want to use SPS signals for determining position in outdoor environments, while using WiFi for indoor environments.

Raster and vector based image files containing maps for indoor venues are readily available to the public. However, the building boundary is commonly not pre-defined in these image files.

### BRIEF SUMMARY

According to one aspect of the present disclosure, a computer-implemented method for detecting a boundary of a building from an indoor map includes providing an electronic raster image of the indoor map. A floor plan included in the map is a first color and a background of the image is a second color. The method includes scanning the image a first time in a plurality of directions and coloring pixels of the image a third color as they are scanned the first time until a pixel is detected that is not the second color. Then the image is scanned a second time in at least two directions. The second scan includes marking a pixel a fourth color for each third color to non-third color and each non-third color to third color transition. The resultant pixels of the fourth color represent the boundary of the building.

According to another aspect of the present disclosure, a computer-readable medium includes program code stored thereon for detecting a boundary of a building from an indoor map. The program code includes instructions to provide an electronic raster image of the indoor map, where a floor plan included in the map is a first color and a background of the image is a second color. The program code further includes instructions to scan the raster image a first time in a plurality of directions and to color pixels of the raster image a third color as they are scanned the first time until a pixel is detected that is not the second color. The program code also includes instructions to scan the raster image a second time in at least two directions and marking a pixel a fourth color for each third color to non-third color and each non-third color to third color transition, where the pixels of the fourth color represent the boundary of the building.

In a further aspect of the present disclosure, a map server includes memory and a processing unit. The memory is adapted to store program code for detecting a boundary of a building from an indoor map. The processing unit is adapted to access and execute instructions included in the program code. When the instructions are executed by the processing unit, the processing unit directs the map server to provide an electronic raster image of the indoor map, where a floor plan included in the map is a first color and a background of the image is a second color. The processing unit also directs the map server to scan the raster image a first time in a plurality of directions and to color pixels of the raster image a third color as they are scanned the first time until a pixel is detected that is not the second color. The processing unit then directs the map server to scan the raster image a second time in at least two directions and marking a pixel a fourth color for each third color to non-third color and each non-third color to third color transition, where the pixels of the fourth color represent the boundary of the building.

In yet another aspect of the present disclosure, a system for detecting a boundary of a building from an indoor map includes means for providing an electronic raster image of the indoor map, where a floor plan included in the map is a first color and a background of the image is a second color. The system also includes means for scanning the raster image a first time in a plurality of directions and coloring pixels of the raster image a third color as they are scanned the first time until a pixel is detected that is not the second color. Further included in the system are means for scanning the raster image a second time in at least two directions and marking a pixel a fourth color for each third color to non-third color and each non-third color to third color transition, where the pixels of the fourth color represent the boundary of the building.

The above and other aspects, objects, and features of the present disclosure will become apparent from the following description of various embodiments, given in conjunction with the accompanying drawings.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 illustrates a process of automatically detecting a boundary of a building from an indoor map.

FIG. 2 illustrates an example image including an indoor map of a building.

FIG. 3A illustrates the example image of FIG. 2 scanned in a first direction from top to bottom of the image.

FIGS. 3B and 3C illustrate a portion of the example image of FIG. 2 scanned in the first direction from top to bottom of the image.

FIG. 4 illustrates the example image of FIG. 2 scanned in a second direction from bottom to top of the image.

FIG. 5A illustrates the example image of FIG. 2 scanned in a third direction from left to right of the image.

FIGS. 5B and 5C illustrate a portion of the example image of FIG. 2 scanned in the third direction from left to right of the image.

FIG. 6 illustrates the example image of FIG. 2 scanned in a fourth direction from right to left of the image.

FIG. 7 illustrates the example image of FIG. 2 scanned from four directions.

FIG. 8 illustrates the example scanned image of FIG. 7, scanned a second time to generate a boundary of the building.

FIG. 9 illustrates the detection of gaps in the building boundary of FIG. 8.

FIG. 10 illustrates the filling of the detected gaps in the image of FIG. 9.

FIG. 11 illustrates a process of reducing the number of lines in a boundary of a building.

FIG. 12A illustrates a reduction in the number of lines included in the building boundary of FIG. 10.

FIGS. 12B and 12C illustrate an example line merging of a building boundary.

FIG. 13 is a functional block diagram of a navigation system.

FIG. 14 is a functional block diagram of a map server.

### DETAILED DESCRIPTION

Reference throughout this specification to “one embodiment”, “an embodiment”, “one example”, or “an example” means that a particular feature, structure, or characteristic described in connection with the embodiment or example is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Any example or embodiment described herein is not to be construed as preferred or advantageous over other examples or embodiments.

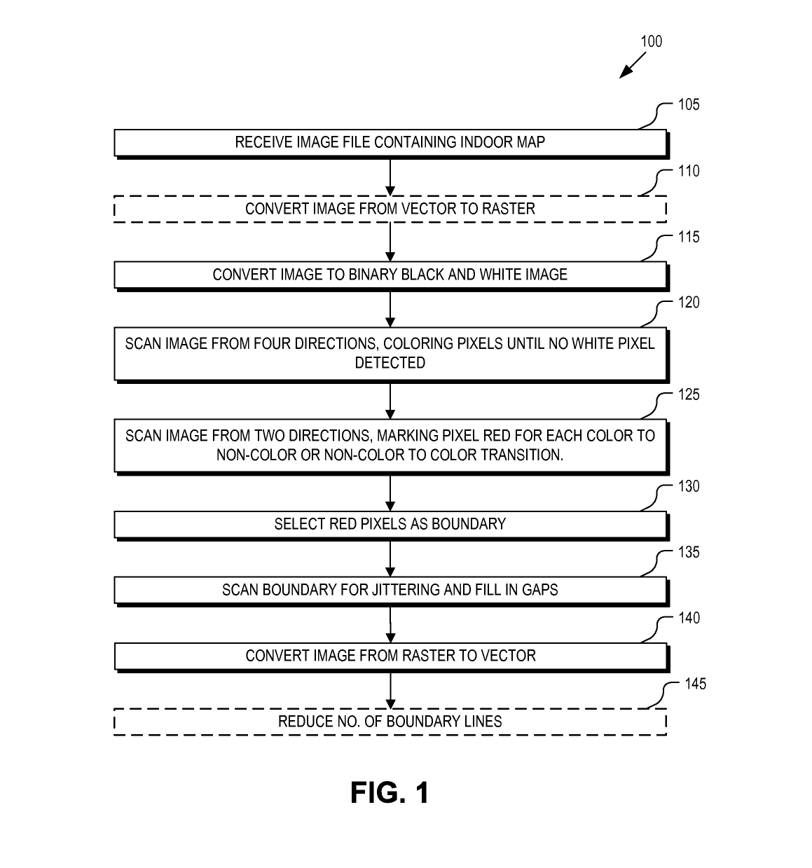

FIG. 1 illustrates a process 100 of automatically detecting a boundary of a building from an indoor map. In process block 105, an image file that contains an indoor map is received. In one embodiment, the image file is a raster image file that does not contain any semantic information. The raster image file may be in a variety of formats, including, but not limited to, *.bmp, *.jpeg, *.tiff, *.raw, *.gif, *.png, etc. In another embodiment the received image file is a vector based file, such as, *dxf, *cad, *kml, etc. In the embodiment of the received image file being vector based, process 100 includes optional process block 110 for converting the image file from vector based to a raster image. In addition, the vector based image file may contain multiple layers each showing separate features of a building structure. For example, a vector based image file may include a door layer showing the doors included in the building. In this embodiment, converting the vector based image file to a raster image may include overlaying the map with the door layer prior to generating the raster image so as to close off, at least, some of the openings in the building.

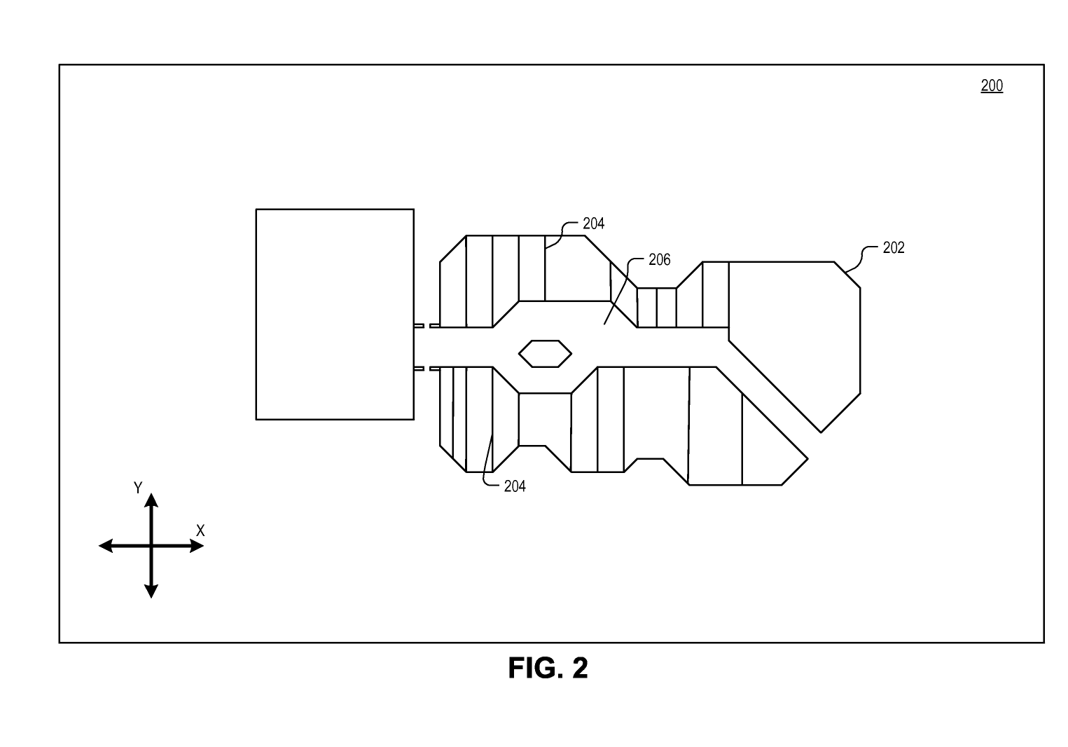

Next, in process block 115, the raster image is converted into a two-tone binary image. In one embodiment, the two-tone binary image is a black and white binary image with white pixels representing the background and the floor plan of the building represented by black pixels. As will be used hereinafter, black pixels of the binarized image file will represent the floor plan of the building, while white pixels represent the background. However, other embodiments may include binarization of the image using two other distinct colors instead of black and white, in accordance with the teachings of the present disclosure. FIG. 2 illustrates an example of a binarized raster image 200 including an indoor map of a floor plan 202. In one embodiment, raster image 200 is an indoor map of a shopping mall illustrating interior walls 204 and open spaces 206, but in other embodiments, raster image 200 may include indoor maps of other building structures, such as an office space, an airport terminal, a university building, etc. As shown in FIG. 2, floor plan 202 is represented with black pixels, while the background is shown with white pixels.

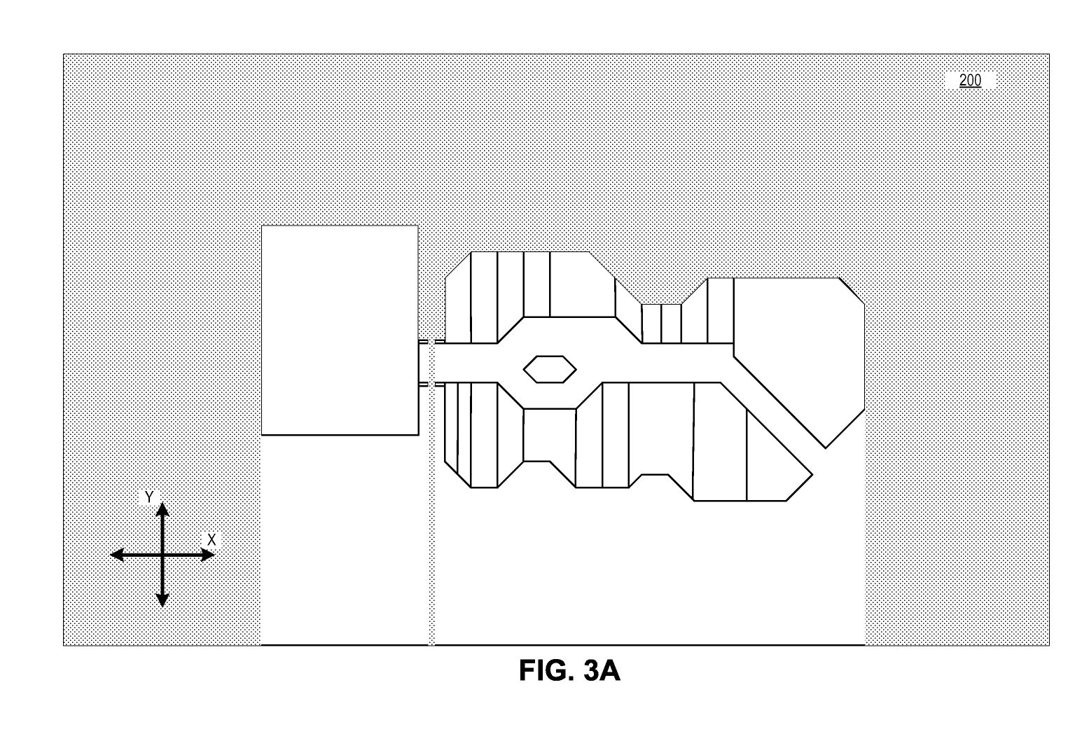

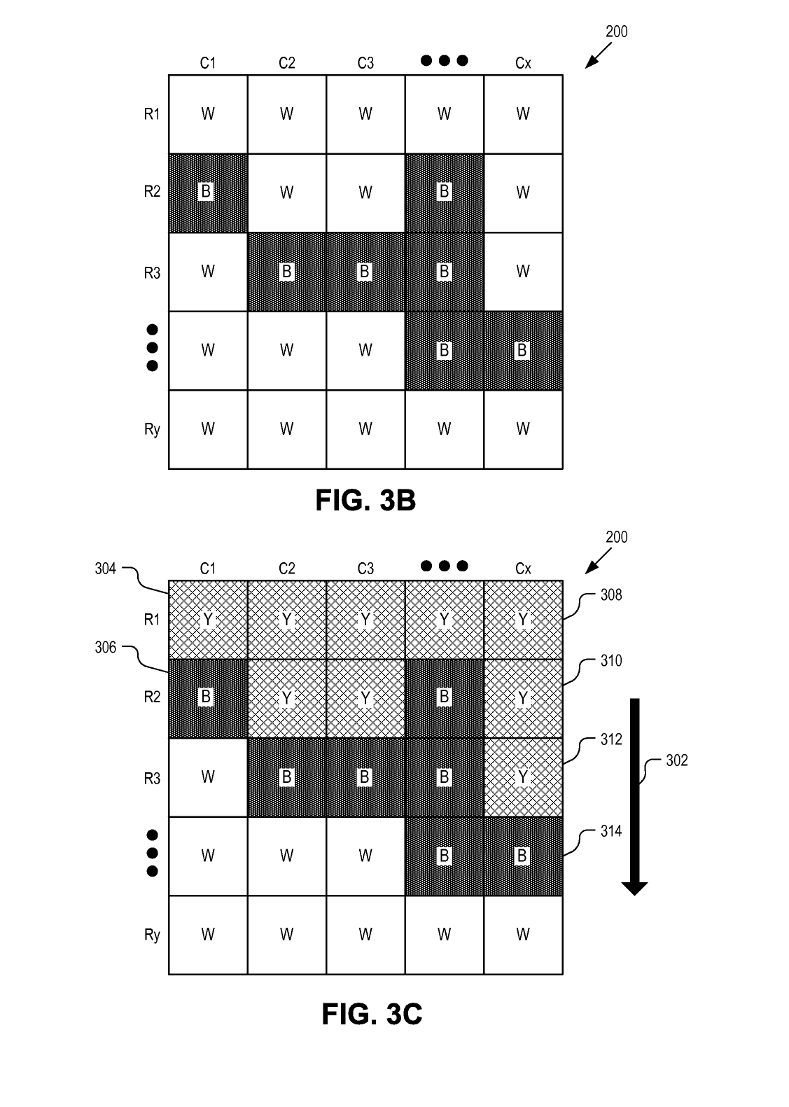

Referring now back to FIG. 1, process 100 proceeds to process block 120, which includes scanning the raster image a first time from a plurality of directions and coloring pixels of the image as they are scanned until a pixel is detected that is not the background color (e.g., not white). FIGS. 3A-6 illustrate the image 200 being scanned in four directions. In one embodiment, the first direction is orthogonal to the second direction; the second direction orthogonal to the third direction, the third direction orthogonal to the fourth direction, and the fourth direction orthogonal to the first direction. Although the directions may be orthogonal to one another, the directions need not be orthogonal to the floor plan 202. That is, floor plan 202 may be at any angle with respect to the x and/or y-axis and still benefit from the teachings of the present disclosure.

Also, as shown, pixels of image 200 are colored a third color (shown in the figures as shading) as they are scanned in a direction until a non-white (e.g., black) pixel is detected. In one embodiment, the third color is yellow, but in other embodiments, may be any color that is distinct from the background (e.g., white) and foreground (e.g., black) colors.

First, FIG. 3A illustrates image 200 scanned in a first direction from top to bottom of the image along the y-axis. Further details of the scanning of image 200 in the first direction from top to bottom are provided below with reference to FIGS. 3B and 3C.

Pixels of the raster image are arranged into a plurality of rows and columns, where scanning the raster image includes coloring pixels of each column in the first direction, and each row in a second direction, until a pixel is detected in each respective column/row that is not the background color. For example, FIG. 3B illustrates a portion of image 200 where each pixel is arranged into a row (e.g., rows R1 to Ry) and a column (e.g., column C1 to Cx). Background pixels are shown as white (W), while foreground pixels (e.g., floor plan 202) are shown as black (B). FIG. 3C illustrates the portion of image 200 after the image has been scanned in the first direction 302 from top to bottom. As shown, pixels of each column were colored yellow (Y) from top to bottom until a non-background color (in this case black) was reached. By way of example, in the first column C1, a first pixel 304 was colored yellow and then coloring of this column stopped because black pixel 306 was reached. Similarly, the first two pixels were colored yellow in both column C2 and column C3. Each remaining column of image 200 is then scanned in this first direction 302 similar to that of columns C1-C3 including the last column Cx. In column Cx, the first three pixels 308, 310, and 312 were colored yellow and then coloring of column Cx stopped because black pixel 314 was reached.

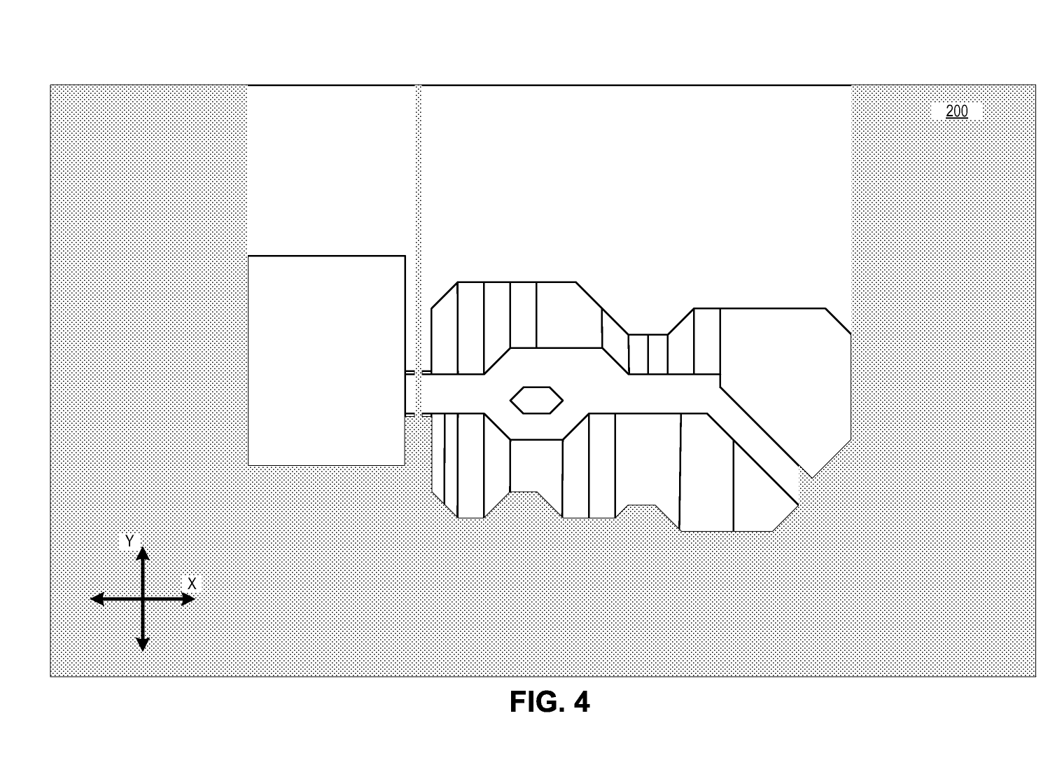

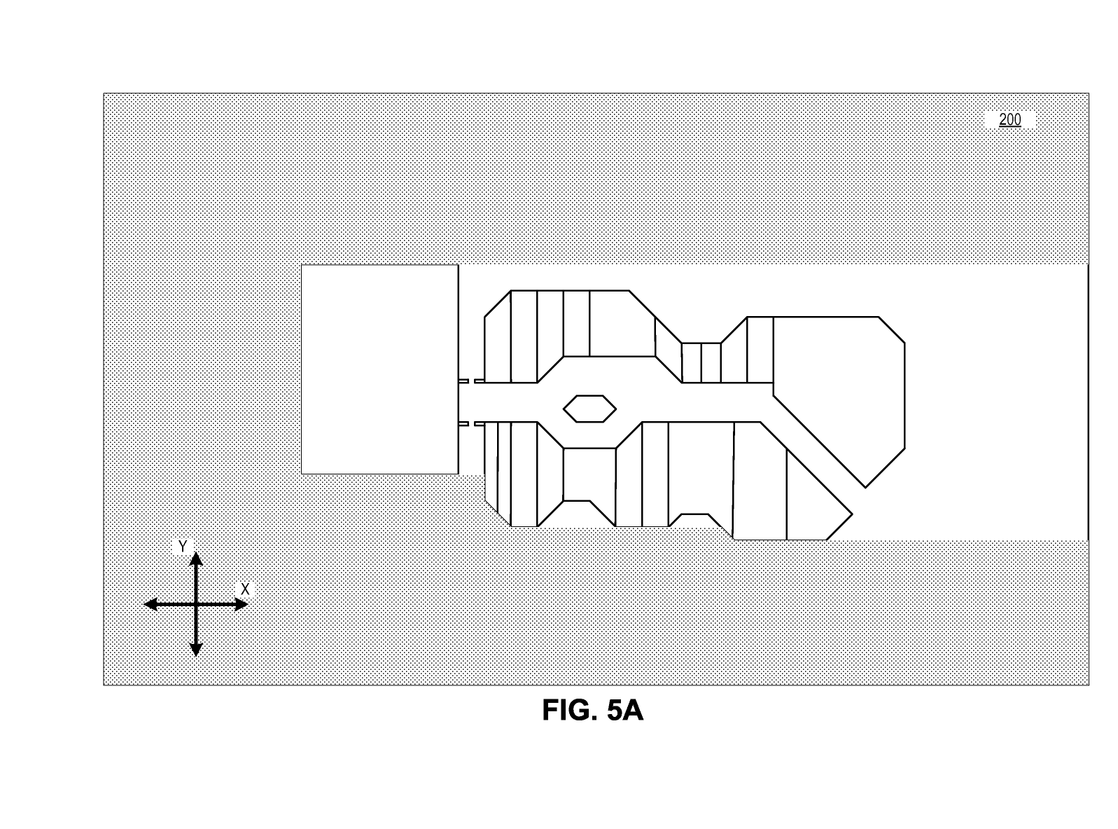

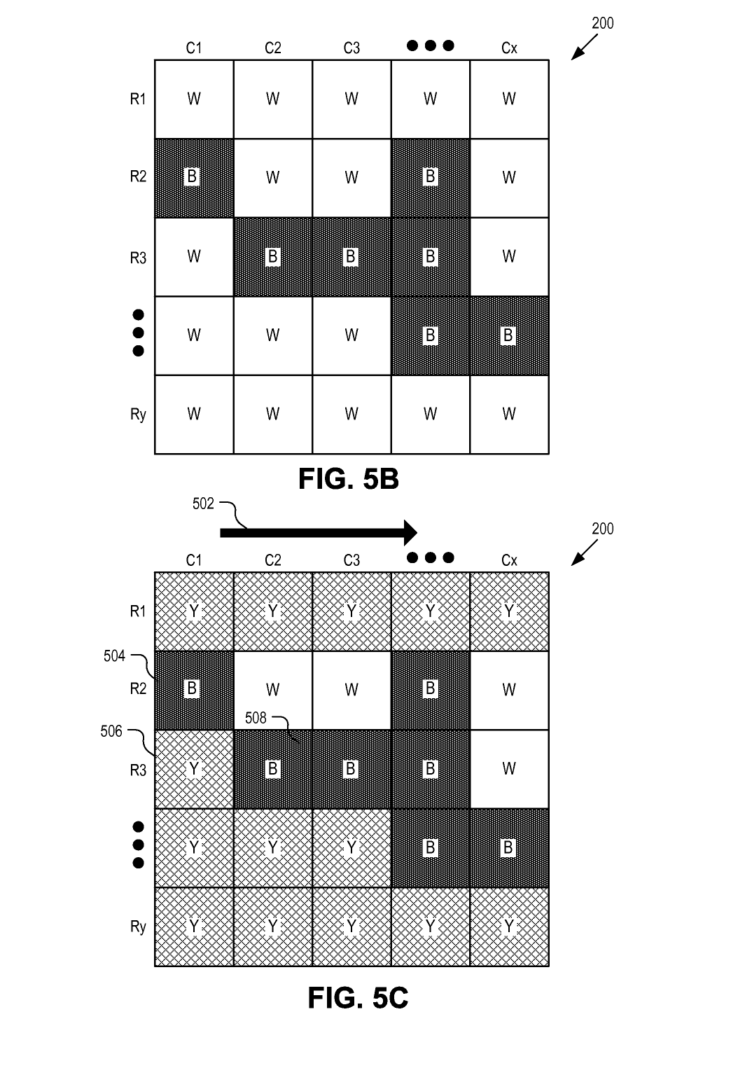

FIG. 4 illustrates image 200 scanned in a second direction from bottom to top of the image along the y-axis, where pixels of each column are colored yellow from bottom to top of the image until a black pixel is detected. FIG. 5A illustrates image 200 scanned in a third direction from left to right of the image along the x-axis. Further details of the scanning of image 200 in the third direction from left to right are provided below with reference to FIGS. 5B and 5C.

Similar to FIG. 3B, discussed above, FIG. 5B illustrates a portion of image 200 where each pixel is arranged into a row (e.g., rows R1 to Ry) and a column (e.g., column C1 to Cx). Background pixels are shown as white (W), while foreground pixels (e.g., floor plan 202) are shown as black (B). FIG. 5C illustrates the portion of image 200 after the image has been scanned in the third direction 502 from left to right. As shown, pixels of each row were colored yellow (Y) from left to right until a non-background color (in this case black) was reached. By way of example, in the first row R1, all pixels were colored yellow because no black pixel was detected in this row. However, in row R2, no pixels are colored yellow because the first pixel 504 that was scanned is black. In row R3, the first pixel 506 of this row is colored yellow and then scanning of this row stops because black pixel 508 was reached. Each remaining row of image 200 is then scanned in this third direction 502 similar to that of rows R1-R3, including the last row Ry.

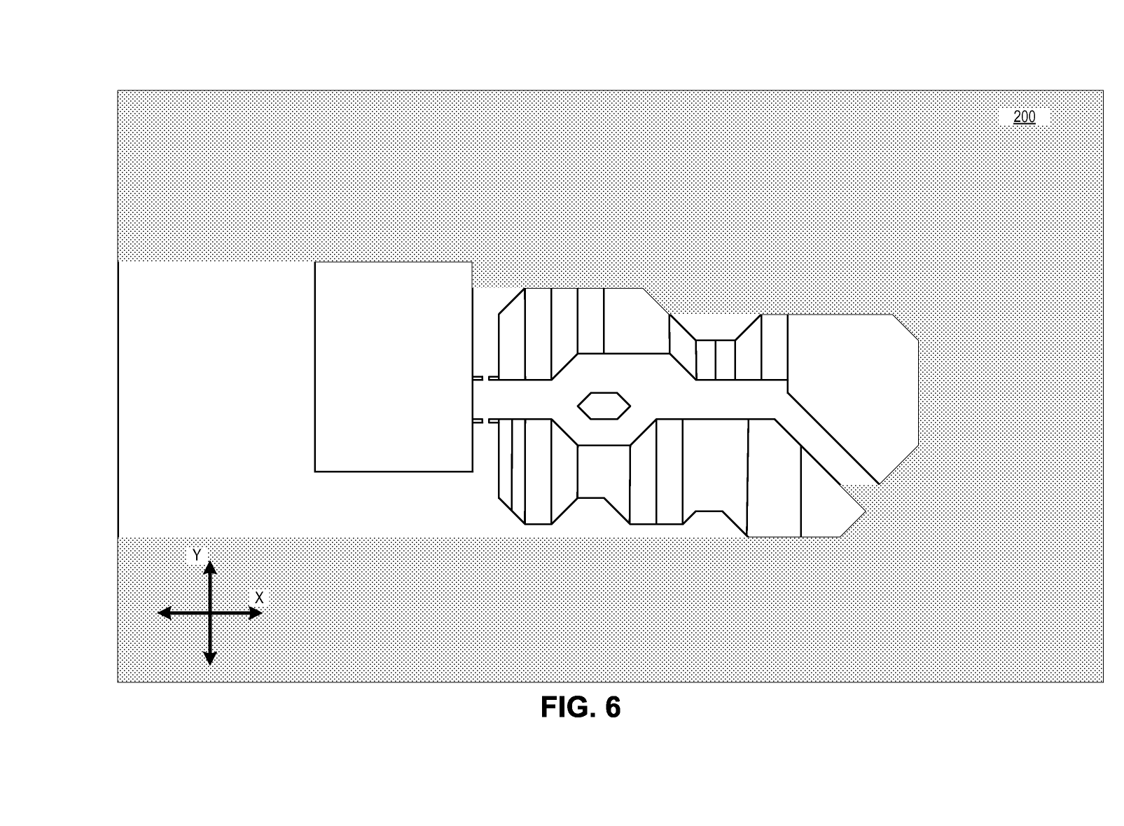

FIG. 6 illustrates image 200 scanned in a fourth direction from right to left of the image along the x-axis, where pixels of each row are colored yellow from right to left of the image until a black pixel is detected.

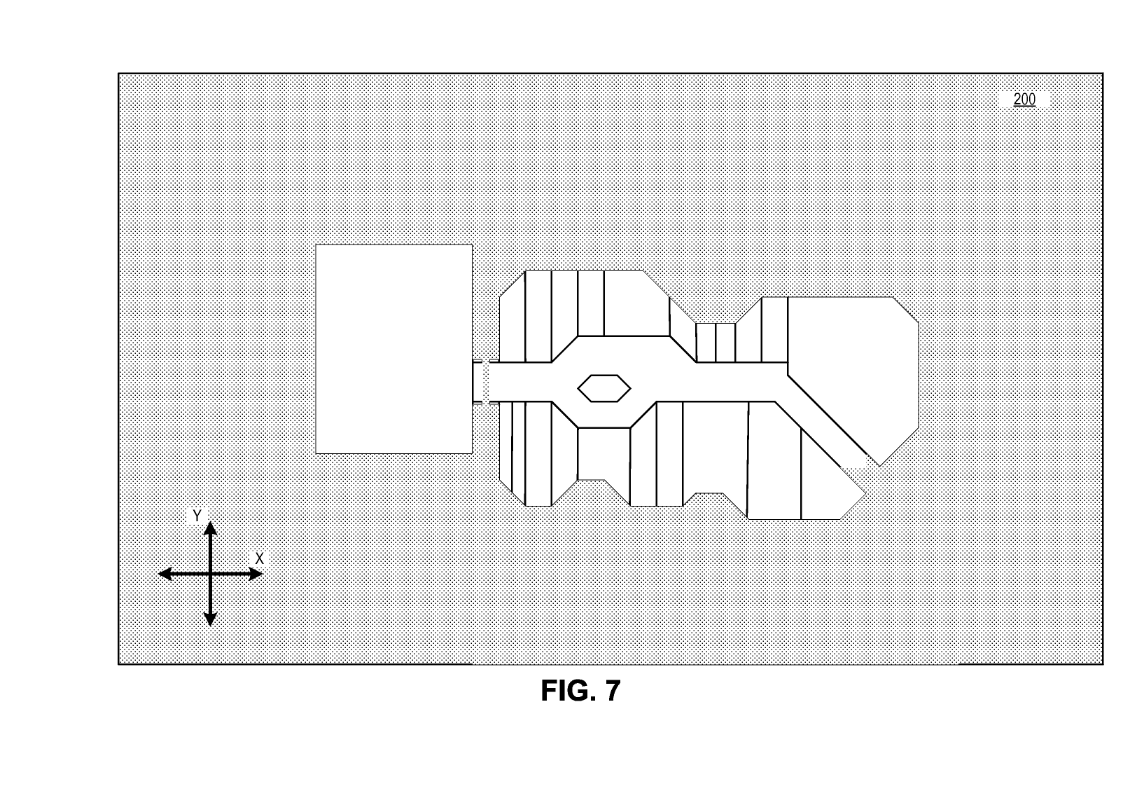

FIG. 7 is the culmination of FIGS. 3A-6 and illustrates image 200 scanned in all four directions. Although FIGS. 3A-6 scan the image in only four directions, other embodiments may include scanning the image any number in any number of directions including four or more.

As shown in FIG. 1, process 100, next, proceeds to process block 125 where image 200 is scanned a second time in at least two directions, where during the second scan pixels are marked a fourth color for each third color (e.g., yellow) to non-third color and each non-third color to third color transition. In one embodiment, the fourth color is red, but in other embodiments the fourth color may be any color that is distinct from the foreground color (e.g., black), the third color (e.g., yellow) and the background color (e.g., white). The second scan in two directions may include scanning the image in a first direction from top to bottom along the y-axis, and in a second direction from left to right along the x-axis. However, in other embodiments, the first and second directions may be any direction, provided that the two directions are substantially orthogonal to one another.

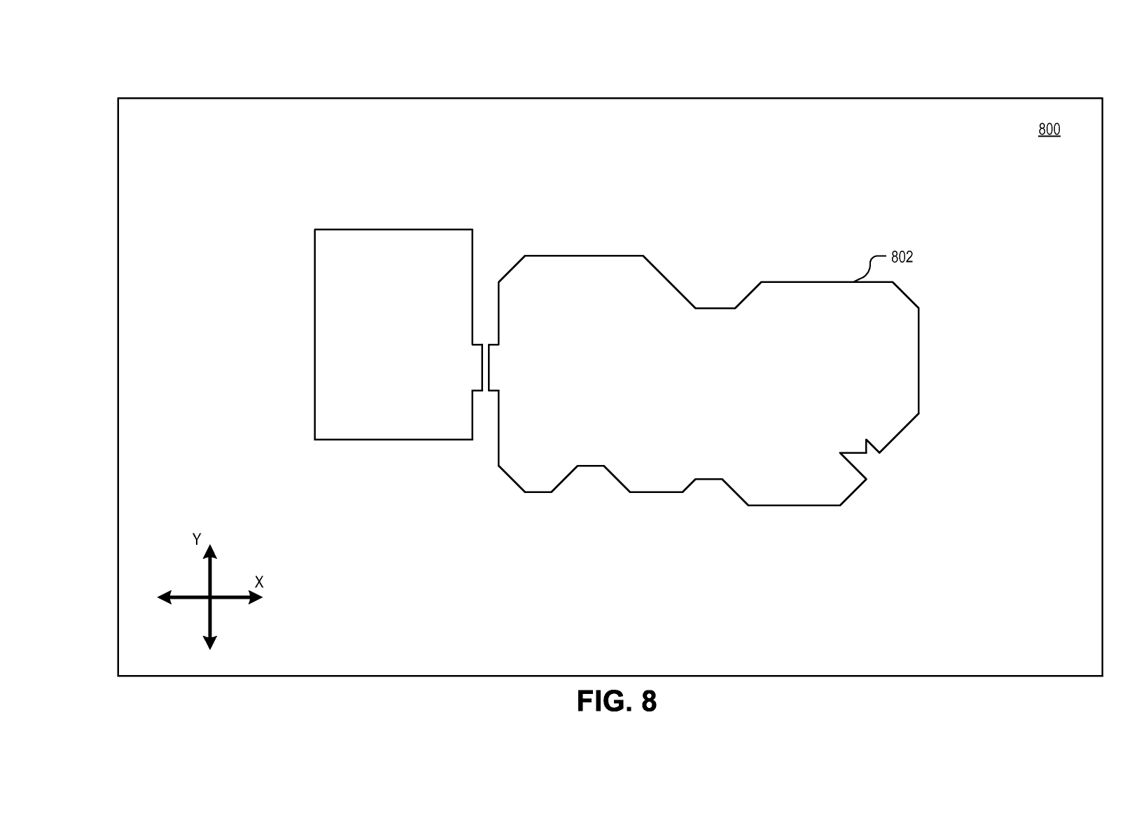

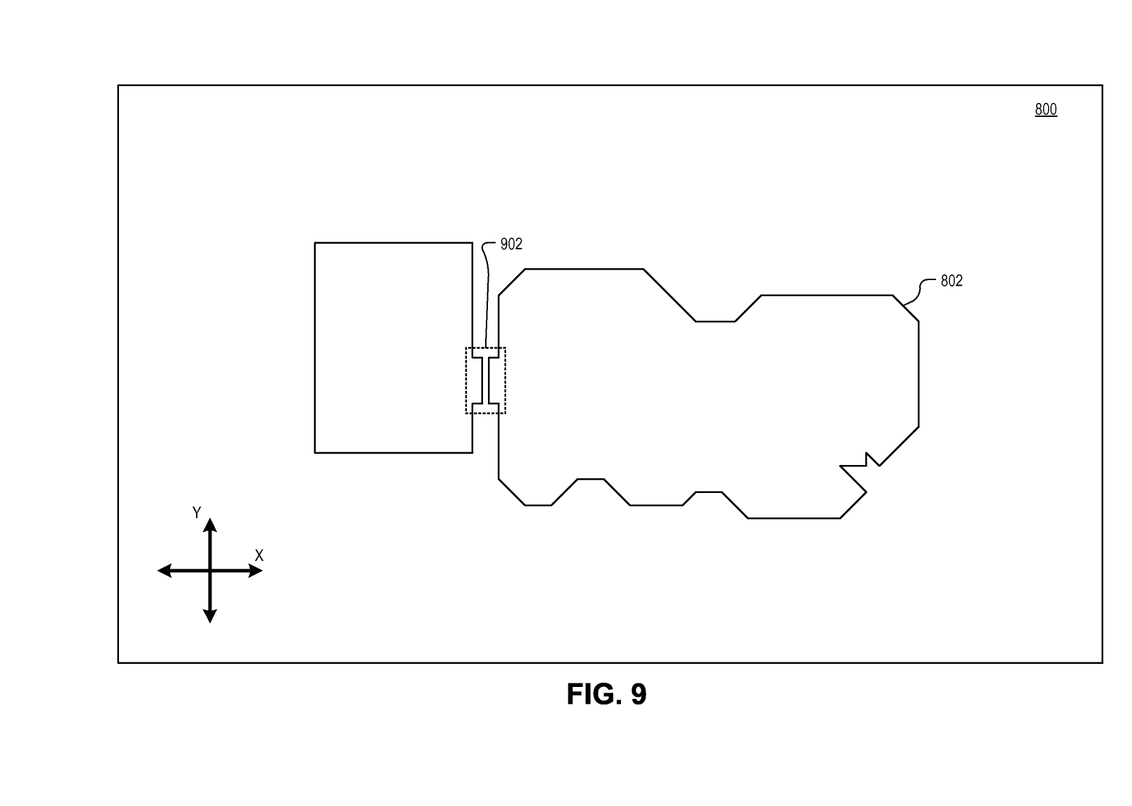

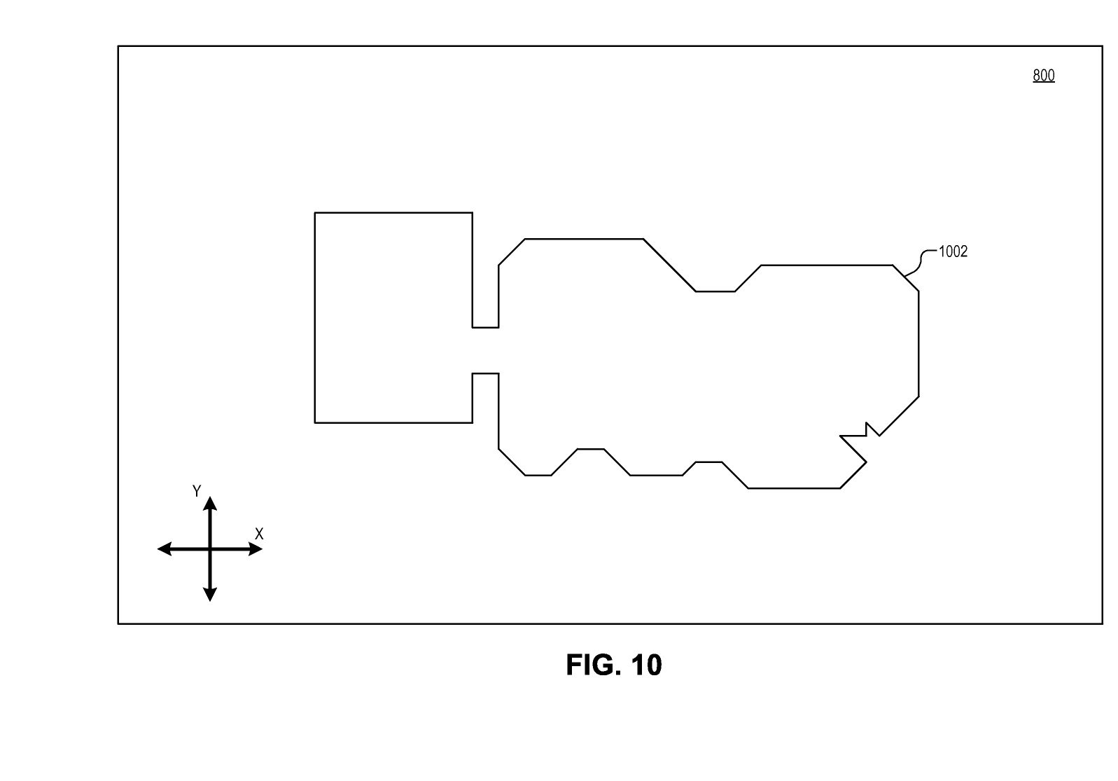

FIG. 8 illustrates an example scanned image 800. Scanned image 800 may represent image 200 of FIG. 7, scanned the second time to generate a boundary 802 of the building. That is, for each yellow to non-yellow and each non-yellow to yellow transition, a pixel was marked red to represent the boundary 802. In process block 130 it is these red pixels that are selected as the boundary 802. However, as can be seen the boundary 802 may include gaps due to openings that were present in the boundary of the original raster image. Thus, process 100 may proceed to process block 135 which includes scanning the image for jittering and filling the gaps of the building boundary to form a single polygon. By way of example, FIG. 9 illustrates the detection of gap 902 in the boundary 802. In one embodiment, gaps are detected by comparing points of the image file that are in close proximity but yet disconnected from one another. FIG. 10 illustrates the filling of the detected gap 902 to form a single closed polygon 1002 in image 800.

Next, in process block 140, image 800 is converted from a raster to a vector image through vectorization. The vectorization technique utilized may be a known vectorization method, such as Edge Detection, Feature Detection, and Skeletonization.

Although the image 800 of FIG. 9 accurately illustrates the boundary 802, the boundary may include a prohibitive number of line segments, so as to make further processing difficult and/or expensive. Thus, process 100 includes optional process block 145 for reducing the number of line segments included in the building boundary.

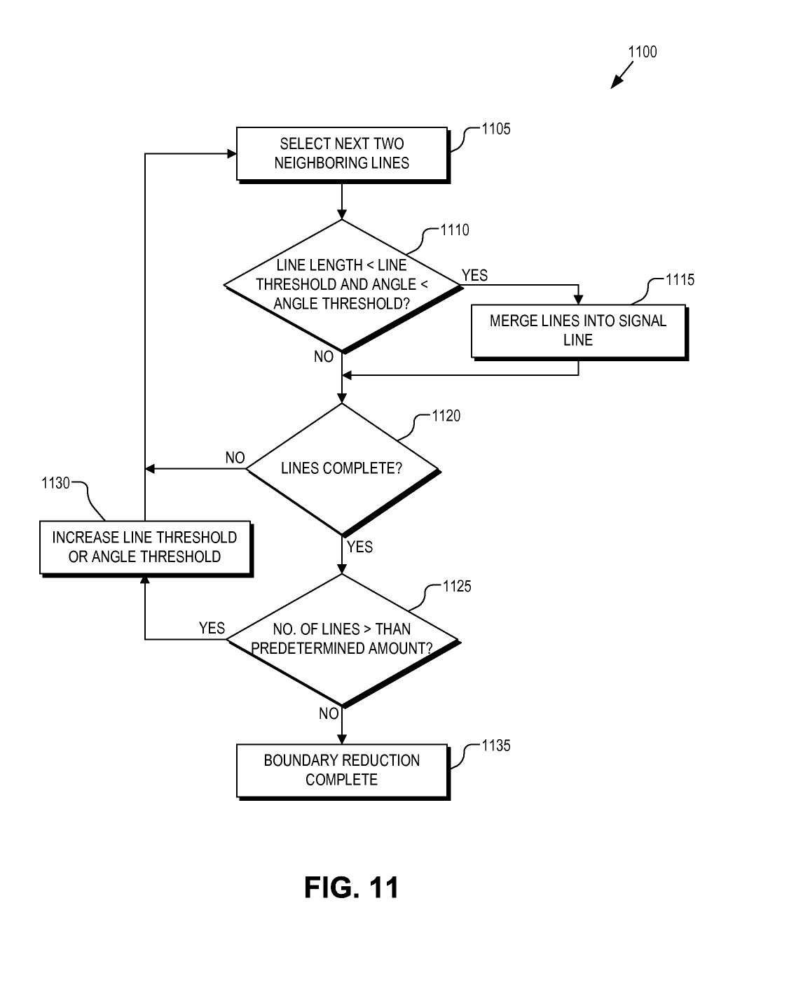

For example, FIG. 11 illustrates a process 1100 of reducing the number of lines in a detected boundary of a building. Process 1100 is one possible implementation of process block 145 of FIG. 9. Process 1100 is an iterative process that includes analyzing and merging neighboring lines until the total number of line segments is less than a predetermined amount. In process block 1105, two neighboring lines are selected for analysis. In decision block 1110, it is determined whether the length of one of the lines is less than a line threshold and whether the angle between the two lines is less than an angle threshold. If yes to both, process proceeds to process block 1115 where the two lines are merged into a single line. Decision block 1120 determines whether all the lines in the boundary have been processed. If not, process 1100 proceeds back to process block 1105 to select the next two neighboring lines for analysis.

If all the lines in the building boundary have been analyzed, decision block 1125 then compares the total number of remaining line segments with a predetermined amount. If the number of line segments is greater than the predetermined amount, then one of the thresholds (i.e., line threshold or angle threshold) is increased in process block 1130. In one embodiment, only one of the line threshold or angle thresholds are increased during each iteration of process 1100. That is, during the first iteration, process block 1130 may increase the line threshold only. During subsequent iterations, the angle threshold may be increased until an upper angle limit is reached. Once the upper angle limit is reached, the angle threshold may be reset to a lower angle limit and the line threshold increased. In one embodiment, the upper angle limit is 180 degrees, the lower angle limit is 10 degrees, and the initial line threshold is one meter. Thus, by way of example, the line threshold may be initially set to 1 meter and the angle threshold initially set to 10 degrees. Each subsequent iteration of process 1100 increases the angle threshold until it reaches 180 degrees, at which point the next iteration includes setting the angle threshold back to 10 degrees and increasing the line threshold to 2 meters, for example.

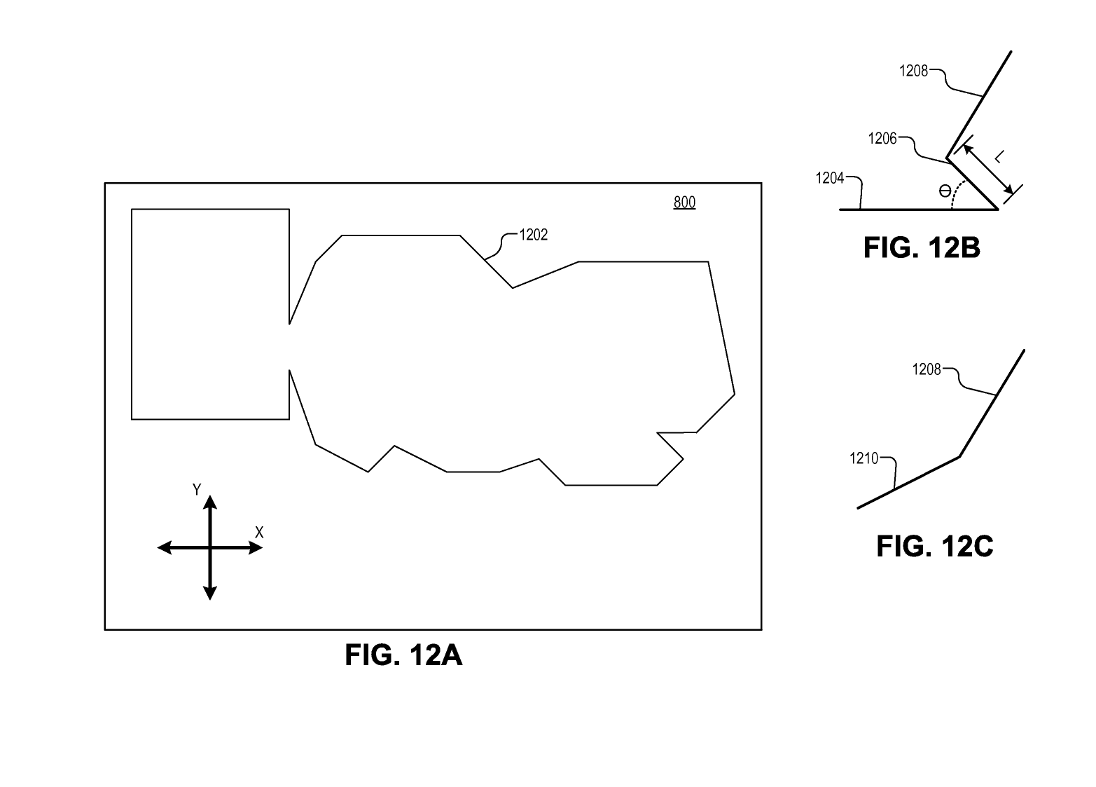

FIG. 12A illustrates a reduction in the number of lines included in the boundary 802 of FIG. 10 to generate boundary 1202. FIGS. 12B and 12C illustrate an example of line merging, in accordance with embodiments of the present disclosure. FIG. 12B illustrates a portion of a building boundary as including three line segments 1204, 1206, and 1208. During the analysis of neighboring line segments 1204 and 1206 it is determined that line segment 1206 has a length L that is less than the line threshold, and that the angle θ between the two line segments is less than the angle threshold. Thus, FIG. 12C illustrates line segments 1204 and 1206 merged together as a single line segment 1210.

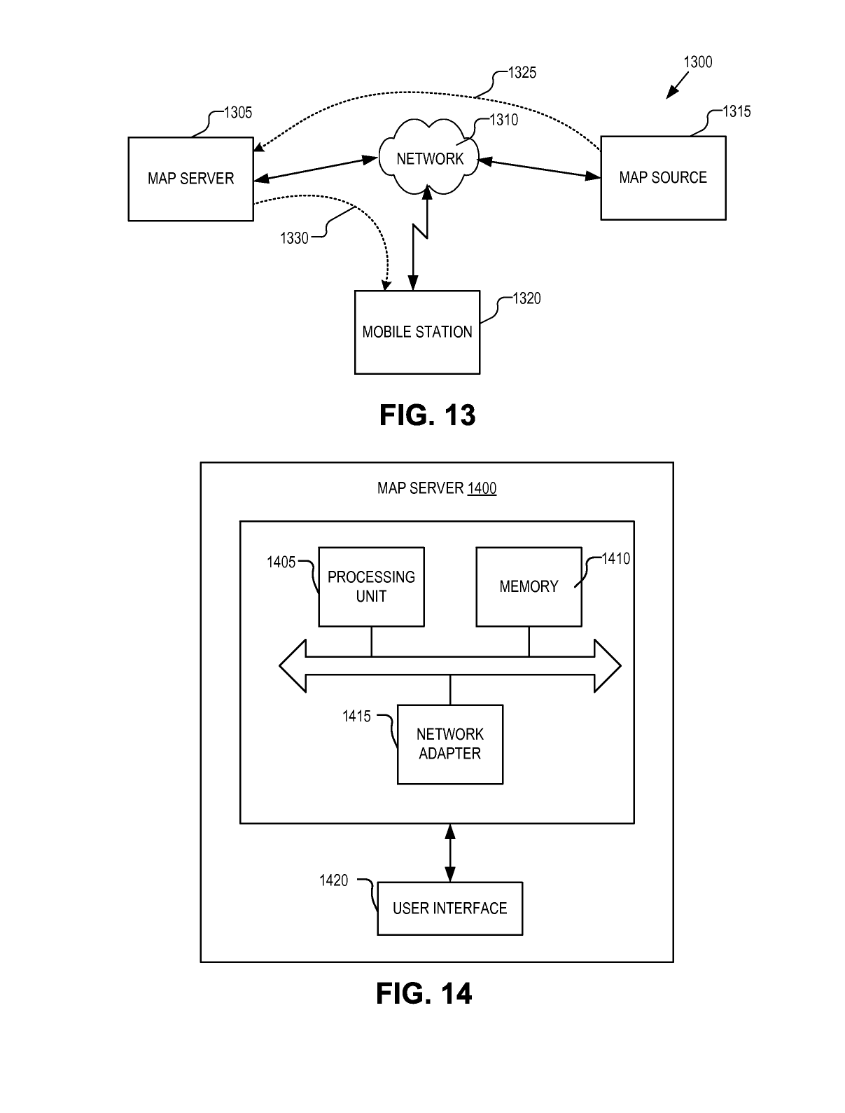

FIG. 13 is a functional block diagram of a navigation system 1300. As shown, navigation system 1300 may include a map server 1305, a network 1310, a map source 1315, and a mobile device 1320. Map source 1315 may comprise a memory and may store electronic maps that may or may not contain any annotations or other information indicating the building boundary, for example. The electronic maps may include drawings of line segments which may indicate various interior features of a building structure.

In one implementation, map source 1315 may create electronic maps by scanning paper blueprints for a building into an electronic format that does not include any annotations. Alternatively, map source 1315 may acquire electronic maps from an architectural firm that designed a building or from public records, for example.

Electronic maps 1325 may be transmitted by map source 1315 to map server 1305 via network 1310. Map source 1315 may comprise a database or server, for example. In one implementation, map server 1305 may transmit a request for a particular basic electronic map to map source 1315 and in response the particular electronic map may be transmitted to map server 1805. One or more maps in map source 1315 may be scanned from blueprint or other documents.

Map server 1305 automatically detects the building boundary utilizing the methods disclosed herein. In one embodiment, map server 1305 may provide a user interface for a user to adjust or modify the building boundary that was automatically detected. In response to user input, the shape of the single polygon used to represent the building boundary may be changed.

The electronic map with the identified building boundary may subsequently be utilized by a navigation system to generate various position assistance data that may be used to provide routing directions or instructions to guide a person from a starting location depicted on a map to a destination location in an office, shopping mall, stadium, or other indoor environment. In one embodiment, the generation of position assistance data for the mobile station is limited to the building boundary so as to reduce processing times. The building boundary may also be utilized to decide between various methods of determining position, whether it be SPS in outdoor environments or WiFi for indoor environments, both determined by the building boundary.

As discussed above, electronic maps and/or routing directions 1330 may be transmitted to a user's mobile station 1320. For example, such electronic maps and/or routing directions may be presented on a display screen of mobile station 1320. Routing directions may also be audibly presented to a user via a speaker of mobile station 1320 or in communication with mobile station 1320. Map server 1305, map source 1315 and mobile station 1320 may be separate devices or combined in various combinations (e.g., all combined into mobile device 1320; map source 1315 combined into map server 1305, etc.).

FIG. 14 is a functional block diagram of a map server 1400. Map server 1400 is one possible implementation of map server 1305 of FIG. 13. Map server 1400 may include a processing unit 1405, memory 1410, and a network adapter 1415. Memory 1410 may be adapted to store computer-readable instructions, which are executable to perform one or more of processes, implementations, or examples thereof which are described herein. Processing unit 1405 may be adapted to access and execute such machine-readable instructions. Through execution of these computer-readable instructions, processing unit 1405 may direct various elements of map server 1400 to perform one or more functions.

Memory 1410 may also store electronic maps to be analyzed for the automatic detection of the building boundary of a building included in the electronic map. Network adapter 1415 may transmit one or more electronic maps to another device, such as a user's mobile device. Upon receipt of such electronic maps, a user's mobile device may present updated electronic maps via a display device. Network adapter 1415 may also receive one or more electronic maps for analysis from an electronic map source. User interface 1420 may be included in map server 1400 to display to a user the automatically detected building boundary. In one embodiment, user interface 1420 is configured to allow a user to adjust or modify the building boundary that was automatically detected. That is, the shape of the single polygon used to represent the building boundary may be changed according to user input.

The order in which some or all of the process blocks appear in each process should not be deemed limiting. Rather, one of ordinary skill in the art having the benefit of the present disclosure will understand that some of the process blocks may be executed in a variety of orders not illustrated.

The teachings herein may be incorporated into (e.g., implemented within or performed by) a variety of apparatuses (e.g., devices). For example, one or more aspects taught herein may be incorporated into a mobile station, phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device. These devices may have different power and data requirements and may result in different power profiles generated for each feature or set of features.

As used herein, a mobile station (MS) refers to a device such as a cellular or other wireless communication device, personal communication system (PCS) device, personal navigation device (PND), Personal Information Manager (PIM), Personal Digital Assistant (PDA), laptop, tablet or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile station.”

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments referred to various colors, color-blocks, colored lines, etc. It is noted that the drawings accompanying this disclosure include various hatching, cross-hatching, and shading to denote the various colors, color-blocks, and colored lines.

Various modifications to the embodiments disclosed herein will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method for detecting a boundary of a building from an indoor map, the method comprising:
providing an electronic raster image of the indoor map, wherein a floor plan included in the map is a first color and a background of the image is a second color;
scanning the raster image a first time in a plurality of directions and coloring pixels of the raster image a third color as they are scanned the first time until a pixel is detected that is not the second color; and
scanning the raster image a second time in at least two directions and marking a pixel a fourth color for each third color to non-third color and each non-third color to third color transition, wherein the pixels of the fourth color represent the boundary of the building.

2. The method of claim 1, wherein pixels of the raster image are arranged into a plurality of rows and columns, wherein scanning the raster image the first time in a plurality of directions includes coloring pixels of each column in a first direction until a pixel is detected in each respective column that is not the second color.

3. The method of claim 2, wherein scanning the raster image the first time in a plurality of directions includes coloring pixels of each row in a second direction until a pixel is detected in each respective row that is not the second color.

4. The method of claim 1, further comprising converting the raster image to a two-tone binary image.

5. The method of claim 1, wherein scanning the raster image the first time in the plurality of directions includes scanning the raster image in a first direction, a second direction, a third direction, and a fourth direction, wherein the first direction is orthogonal to the second direction, the second direction is orthogonal to the third direction, and the third direction is orthogonal to the fourth direction.

6. The method of claim 5, wherein the first direction is from top to bottom of the raster image, the second direction is from left to right of the raster image, the third direction is from bottom to top of the image, and the fourth direction is from right to left of the raster image.

7. The method of claim 1, wherein scanning the raster image a second time in at least two directions, includes scanning the raster image in a first direction and a second direction, wherein the first direction is orthogonal to the second direction.

8. The method of claim 7, wherein the first direction is one direction selected from the group consisting of: from top to bottom and from bottom to top of the raster image, and wherein the second direction is one direction selected from the group consisting of: from left to right and from right to left of the raster image.

9. The method of claim 1, further comprising:
receiving a vector-based image of the indoor map;
overlaying the indoor map with a door layer; and
generating the electronic raster image of the indoor map based on the indoor map overlaid with the door layer, wherein overlaying the indoor map with the door layer closes off openings in the building prior to scanning the raster image the first time.

10. The method of claim 1, further comprising filling gaps in the building boundary.

11. The method of claim 1, further comprising reducing the number of lines included in the boundary of the building.

12. The method of claim 11, wherein reducing the number of lines includes merging at least two adjacent lines together if a length of one of the two adjacent lines is less than a line length threshold.

13. The method of claim 12, wherein reducing the number of lines includes merging the at least two adjacent lines together if one of the two adjacent lines is less than the line length threshold and if an angle between the two adjacent lines is less than an angle threshold.

14. The method of claim 13, wherein reducing the number of lines further includes increasing the line length threshold if a total number of lines included in the boundary of the building is greater than a predetermined value.

15. The method of claim 13, wherein reducing the number of lines further includes increasing the angle threshold if a total number of lines included in the boundary of the building is greater than a predetermined value.

16. The method of claim 15, wherein reducing the number of lines further includes increasing the angle threshold if the angle threshold is less than an upper angle limit, and if not, increasing the line length threshold and reducing the angle threshold to a lower angle limit.

17. The method of claim 1, further comprising generating position assistance data for a mobile station, wherein the generation of position assistance data is limited to the building boundary so as to reduce the assistance data size and the processing times.

18. A computer-readable medium including program code stored thereon for detecting a boundary of a building from an indoor map, the program code comprising instructions to:
provide an electronic raster image of the indoor map, wherein a floor plan included in the map is a first color and a background of the image is a second color;
scan the raster image a first time in a plurality of directions and to color pixels of the raster image a third color as they are scanned the first time until a pixel is detected that is not the second color; and
scan the raster image a second time in at least two directions and marking a pixel a fourth color for each third color to non-third color and each non-third color to third color transition, wherein the pixels of the fourth color represent the boundary of the building.

19. The computer-readable medium of claim 18, wherein pixels of the raster image are arranged into a plurality of rows and columns, wherein the program code further includes instructions to scan the raster image the first time in a plurality of directions includes first program code to color pixels of each column in a first direction until a pixel is detected in each respective column that is not the second color and second program code to color pixels of each row in a second direction until a pixel is detected in each respective row that is not the second color.

20. The computer-readable medium of claim 18, wherein the program code further comprises instructions to fill gaps in the building boundary.

21. The computer-readable medium of claim 18, wherein the program code further comprises instructions to reduce the number of lines included in the boundary of the building.

22. The computer-readable medium of claim 21, wherein the instructions to reduce the number of lines includes instructions to merge at least two adjacent lines together if a length of one of the two adjacent lines is less than a line length threshold.

23. The computer-readable medium of claim 22, wherein the instructions to reduce the number of lines includes instructions to merge the at least two adjacent lines together if one of the two adjacent lines is less than the line length threshold and if an angle between the two adjacent lines is less than an angle threshold.

24. The computer-readable medium of claim 18, wherein the program code further comprises instructions to generate position assistance data for a mobile station, wherein the generation of position assistance data is limited to the building boundary so as to reduce the assistance data size and the processing times.

25. A map server, comprising:
memory adapted to store program code for detecting a boundary of a building from an indoor map; and
a processing unit adapted to access and execute instructions included in the program code, wherein when the instructions are executed by the processing unit, the processing unit directs the map server to:
provide an electronic raster image of the indoor map, wherein a floor plan included in the map is a first color and a background of the image is a second color;
scan the raster image a first time in a plurality of directions and to color pixels of the raster image a third color as they are scanned the first time until a pixel is detected that is not the second color; and
scan the raster image a second time in at least two directions and marking a pixel a fourth color for each third color to non-third color and each non-third color to third color transition, wherein the pixels of the fourth color represent the boundary of the building.

26. The map server of claim 25, wherein pixels of the raster image are arranged into a plurality of rows and columns, wherein the program code further includes instructions to direct the map server to scan the raster image the first time in a plurality of directions includes first program code to color pixels of each column in a first direction until a pixel is detected in each respective column that is not the second color and second program code to color pixels of each row in a second direction until a pixel is detected in each respective row that is not the second color.

27. The map server of claim 25, wherein the program code further comprises instructions to direct the map server to fill gaps in the building boundary.

28. The map server of claim 25, wherein the program code further comprises instructions to direct the map server to reduce the number of lines included in the boundary of the building.

29. The map server of claim 28, wherein the instructions to reduce the number of lines includes instructions to merge at least two adjacent lines together if a length of one of the two adjacent lines is less than a line length threshold.

30. The map server of claim 29, wherein the instructions to reduce the number of lines includes instructions to merge the at least two adjacent lines together if one of the two adjacent lines is less than the line length threshold and if an angle between the two adjacent lines is less than an angle threshold.

31. The map server of claim 25, wherein the program code further comprises instructions to direct the map server to generate position assistance data for a mobile station, wherein the generation of position assistance data is limited to the building boundary so as to reduce the assistance data size and the processing times.

32. A system for detecting a boundary of a building from an indoor map, the system comprising:
means for providing an electronic raster image of the indoor map, wherein a floor plan included in the map is a first color and a background of the image is a second color;
means for scanning the raster image a first time in a plurality of directions and coloring pixels of the raster image a third color as they are scanned the first time until a pixel is detected that is not the second color; and
means for scanning the raster image a second time in at least two directions and marking a pixel a fourth color for each third color to non-third color and each non-third color to third color transition, wherein the pixels of the fourth color represent the boundary of the building.

33. The system of claim 32, further comprising means to fill gaps in the building boundary.

34. The system of claim 32 further comprising means to reduce the number of lines included in the boundary of the building.

35. The system of claim 34, further comprising means for merging at least two adjacent lines together if a length of one of the two adjacent lines is less than a line length threshold.

36. The system of claim 34, further comprising means for merging at least two adjacent lines together if one of the two adjacent lines is less than the line length threshold and if an angle between the two adjacent lines is less than an angle threshold.

37. The system of claim 32, further comprising mean for generating position assistance data for a mobile station, wherein the generation of position assistance data is limited to the building boundary so as to reduce the assistance data size and the processing times.
